(19) United States
(12) Patent Application Publication
(10) Pub. No.: US 2004/0056958 A1
(43) Pub. Date: Mar. 25, 2004

(54) Video environment for camera

(76) Inventor: Steven K. Lee, Minneapolis, MN (US)

Correspondence Address: Beck & Tysver, P.L.L.C., Suite 100, 2900 Thomas Avenue S., Minneapolis, MN, 55416, US

(21) Appl. No.: 10/669,389

(22) Filed: Sep. 24, 2003

Related U.S. Application Data
(60) Provisional application No. 60/413,178, filed on Sep. 24, 2002.

(51) Int. Cl. H04N 5/225

(52) U.S. Cl. 348/207.1; 348/211.8; 348/207.99; 348/207.11

(57) ABSTRACT

A digital camera is controlled by a user through a screen displaying navigable video content.

This application claims priority to U.S. Ser. No. 60/413,178, filed Sep. 24, 2002 and to U.S. Ser. No. 10/358,931, filed on Feb. 5, 2003, which in turn claims priority to U.S. Ser. No. 60/354,595 filed Feb. 5, 2002.

### FIELD OF THE INVENTION

The present invention relates generally to a video environment in association with a camera for assisting the user in operating the camera, and more particularly to a hosted video environment playing on a touch-sensitive screen of a personal digital assistant (PDA) that is releasably coupled to the camera. The PDA and camera are linked for electronic or data connection therebetween, such that as the user attempts to operate the camera, the camera sends a signal to the PDA to play appropriate video segments to assist the user in successfully operating the camera.

### BACKGROUND OF THE INVENTION

Digital cameras, for both still and moving images, can be complex to operate, particularly for new or infrequent users. What has been needed is help or instructions about operation of the camera that is easily accessible to the user when the user is operating the camera.

Personal digital assistants are popular items that many people carry with them to gain access to stored information, to download data from the internet and to communicate with others. Further, personal digital assistants include a touch-sensitive screen for controlling the PDA and that screen is typically larger than the view screen on a digital camera.

### SUMMARY OF THE INVENTION

The present invention combines advantageous features of a touchscreen with a digital camera to yield a convenient system and method by which a camera user can view information about the camera and its use and enter commands for viewing information and operating the camera. Further, the present invention involves a navigable hosted video environment through which a user can control the camera. The hosted video environment provides a personality or character that interacts with or responds to the user's inputs. In one embodiment, a PDA releasably attaches to the camera and provides a touchscreen for viewing and interacting with the video environment.

### BRIEF DESCRIPTION OF THE DRAWINGS

FIG. 1 is a perspective view of an exemplary version of a personal digital assistant releasably attached to a digital camera.

FIG. 2 is a rear perspective view of the personal digital assistant depicted in FIG. 1;

FIG. 3 is a perspective view of an alternative embodiment of a digital camera incorporating a touchscreen;

FIG. 4 is a rear perspective view of the camera of FIG. 3.

### DETAILED DESCRIPTION OF PREFERRED EMBODIMENT(S)

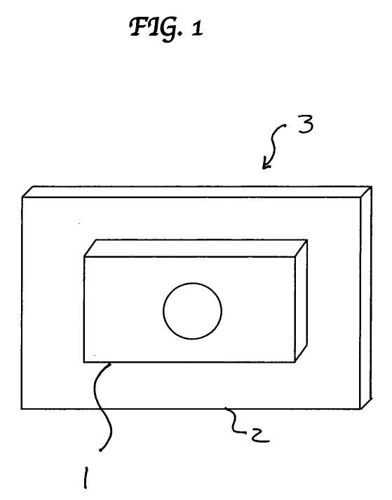

As illustrated in FIG. 1, a camera 1 mechanically engages a personal digital assistant 2 in a selectively releasable manner. In one preferred embodiment, the camera 1 includes structure for receiving and attaching to common PDA shapes, such that a user would be able to use his/her favorite PDA in conjunction with a camera 1 according to this invention. Alternatively, the PDA 2 portion of this device 3 is specially adapted to attach to and interact with a camera 1.

In the preferred, illustrated embodiment of the device 3 in FIG. 1, the PDA attaches to the camera 1 in the horizontal or landscape direction. One advantage achieved in this manner is that the silhouette of the PDA will generally mimic or follow the silhouette of the camera. Further, the landscape orientation of the PDA screen is optimal for text display. The combined unit 3 is relatively compact or easily suited to fitting into typical carrying cases.

The screen 10 on the PDA 2 is used to display images (still or moving) to assist the user in operating the camera. More specifically, a PDA 2 equipped with wireless internet access can access images from a pre-determined web site(s) that relate to operation of the camera. The images may be downloaded or streamed to the PDA 2 and displayed for the user on the PDA's screen 10. Alternatively, such images can be stored in memory on the PDA 2 or on a memory chip or card or stick or the like inserted in the PDA 2. Preferred video or images incorporate navigation cues that allow the user to use the PDA's touchscreen 10 to navigate through the images to display desired information. In an alternative embodiment, a PDA 2 equipped with speakers and an amplifier, uses sound in lieu of or in addition to images.

In a preferred embodiment, the video or sound content incorporates a host personality. Preferably, the user has the opportunity to select a host personality from a set of predefined personalities. The host personality guides the user through content describing the operation of the camera via pre-recorded video segments.

The camera 1 and PDA 2 are linked electronically for data connection therebetween, such that the camera 1 sends signals to the PDA 2 identifying camera functions that the user is attempting to access. In response, the PDA 2 preferably automatically finds and presents video segments pertaining to the camera function(s) the user is attempting to use. In this manner, the combined camera/PDA performs like an on-board helper to provide the user with the information they need when they need it.

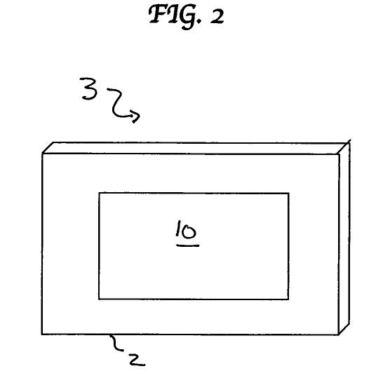

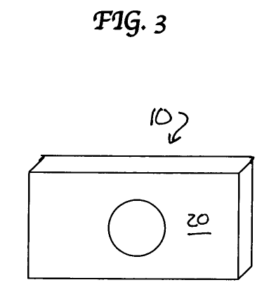

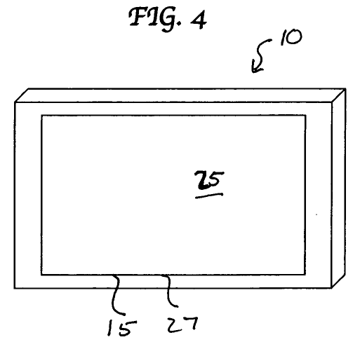

The preferred embodiment described above incorporates a stand-alone PDA which interacts with a camera. This embodiment achieves economies since the user need only own one touchscreen device (rather than paying the additional cost for a second touchscreen on the camera). Nevertheless, a digital camera 10, depicted in FIGS. 3 and 4, according to the invention is alternatively realized without a stand-alone PDA, by combining a user interface device 15 with an image-capturing apparatus 20. The user interface device 15 includes a screen 25 to display content or images regarding the control of the image-capturing apparatus 20. Preferably, the screen 25 is touchsensitive to allow the user to enter commands or input via the screen 25 such that the screen 25 is a user input device 27. Alternatively, buttons, keys or other user input mechanisms are provided. The camera 10 further includes hardware and software for controlling the image-capturing apparatus 20 in response to the user's inputs on the display screen 25 or other input mechanism 27. The content displayed on the touchscreen 25 is preferably navigable video content as described above with respect to the embodiment of FIGS. 1 and 2.

Although an illustrative version of the device is shown, it should be clear that many modifications to the device may be made without departing from the scope of the invention.

It is claimed:

1. A personal digital assistant for operating a digital camera, comprising:
a) a mechanical coupling to a digital camera;
b) an electrical coupling to a digital camera;
c) a touchscreen for displaying control options for controlling the operation of the digital camera that is mechanically and electronically connected to said assistant and for receiving a user's control selections;
d) hardware and software for displaying images on said touchscreen relating to the controls of the camera and for receiving a user's input to control the camera and communicating the user's control inputs to the camera via the electrical coupling.

2. A personal digital assistant according to claim 1, wherein said images are navigable video.

3. A personal digital assistant according to claim 2, wherein said video images are hosted by a personality.

4. A digital camera, comprising:
a) an image-capturing apparatus;
b) a user interface device, coupled to said image-capturing apparatus, by which a user can control said image-capturing apparatus, said user interface including:
(i) a user input device having a touch-sensitive screen to register a user's input;
(ii) hardware and software for controlling and responding to said input device and for controlling said image-capturing apparatus.

5. A digital camera according to claim 4, wherein said user interface device is releasably attached to said camera.

6. A digital camera according to claim 4, wherein said user interface stores and displays video content regarding the control of the image-capturing apparatus and wherein said video is navigable and plays selectively based on user's inputs.

7. A digital camera according to claim 6, wherein said video content portrays a host personality guiding the user through the video content.
